(19) United States
(12) Patent Application Publication
(10) Pub. No.: US 2013/0233996 A1
(43) Pub. Date: Sep. 12, 2013

(54) SELF-GUIDING CELESTIAL TRACKING MOUNT ASSEMBLY

(71) Applicants: Richard James Taylor, Bristol (GB); Lee Gain, Huddersfield (GB)

(72) Inventors: Richard James Taylor, Bristol (GB); Lee Gain, Huddersfield (GB)

(73) Assignee: ASTROTRAC LTD, Bristol (GB)

(21) Appl. No.: 13/988,024

(22) PCT Filed: Nov. 17, 2011
(86) PCT No.: PCT/GB11/01611

§ 371 Date: May 17, 2013

(30) Foreign Application Priority Data
Nov. 20, 2010 (GB) 1019695.4

(51) Int. Cl. F16M 11/18

(52) U.S. Cl. CPC F16M 11/18
USPC 248/550

(57) ABSTRACT

A self-guiding mount for celestial observation equipment and a method of self-guiding, the mount comprising a static plate (6) and a rotational axis assembly (5) rotatably mounted to the static plate (6) and about a rotational axis (2) a rotating means for rotating the rotational axis assembly (5) relative to the plate (6). The mount comprises an optical assembly (14), a camera (34) and a micro-processor (105), the self-guiding mount arranged to self-guide and track a movement of a celestial body relative to the earth.

The present invention relates to equatorial mounts and altitude/azimuth mounts for celestial recording and observation equipment such as cameras, telescopes and satellite communications devices in order to track celestial objects.

For the purposes of visual and photographic celestial observation in particular, it is common to use a celestial object tracking mount that rigidly supports celestial observation or recording equipment to a stand or tripod allowing the equipment to point to and track celestial objects with a high degree of accuracy.

A celestial tracking mount assembly comprises two perpendicular axes that can be rotated to point to, or track, celestial objects. The mount is known as an altitude/azimuth tracking mount when the first axis (azimuth) rotates in a plane parallel to the ground, the second axis (altitude) rotating in a plane perpendicular to the first. Alternatively, the mount is known as an equatorial tracking mount when the first axis (right ascension) is coincident with the celestial pole, the second axis (declination) rotating in a plane perpendicular to the first.

In the prior art, a camera and optics equipment is commonly attached, along with the celestial recording or observation equipment, to the moving axis, known as the declination or altitude axis, to assist in automatically guiding (‘auto-guiding’), pointing and polar alignment.

It is desirable for a celestial object tracking mount to track a celestial object such that the position of the celestial object as seen by the observation or recording equipment remains unchanged. Typically, the position of a celestial object during tracking, as seen by observation or recording equipment, changes over time due to mechanical mount errors and atmospheric refraction and turbulence.

In the prior art, these undesirable movements are typically corrected for by continuously monitoring the position of the celestial object with a camera and optics and processing the resulting position data with a computer. Corrections are calculated and sent to the mount. This closed loop feedback process is commonly known as ‘auto-guiding’.

Auto-guiding is typically carried out by means of an auto-guider camera attached to either a separate telescope with optical axis usually parallel to the optical axis of the main celestial observation or recording equipment known as a ‘guide-scope’, or by means of an ‘off-axis guider’, which diverts some of the light in the optical path of the celestial observation or recording equipment to an auto-guiding camera.

The addition of an auto-guiding camera and optics equipment brings with it a number of challenges. Firstly, the auto-guiding camera and optics must remain rigidly attached and thus true to the axis of the celestial observation or recording equipment. Any flexure or eccentric movement of the mount will result in erroneous reporting of the celestial object tracking mount errors to the auto-guiding computer which will in turn lead to inaccurate corrections being fed back to the mount. Secondly, the auto-guiding camera and optics are typically heavy and bulky to carry by hand; this is particularly problematic considering portability when attempting to reach locations away from human light pollution, especially at altitude. Thirdly, the auto-guiding camera and optics are an additional cost to the user in addition to the celestial object tracking mount and there are often compatibility constraints between different manufacturers.

It is common to utilise a secondary optical and/or camera assembly commonly known as a ‘finder’, with a larger field of view than the primary celestial observation or recording equipment to assist in positioning the primary celestial observation or recording equipment on a celestial object. The ‘finder’ is usually aligned with its axis parallel to that of the primary celestial observation or recording equipment.

It is desirable to use shorter focal length optics in the ‘finder’ compared to the primary celestial observation or recording equipment to aid in rapid acquisition of an image of the celestial object so that its position within the field of view of primary celestial observation or recording equipment can be quickly determined.

The ‘finder’ is typically attached to the celestial observation or recording equipment and is usually separate from the auto-guiding camera and optics.

The ‘finder’ brings to the user similar challenges as presented by the auto-guiding camera and optics.

Prior art equatorial mounts require the right ascension or hour angle axis to be accurately aligned with the celestial pole to avoid tracking errors such as drift and field rotation, this is known as polar alignment.

One popular method of polar alignment utilises a small telescope commonly known as a ‘polar scope’ which is used to offset the right ascension axis of the mount from easily identified stars such as Polaris in the region of the celestial pole such that the right ascension axis is coincident with the celestial pole. In practice, the user looks through the polar scope and uses markings on a clear glass plate known as a reticle, or cross hairs to assist in alignment.

There are a number of circumstances where problems in obtaining accurate polar alignment using a polar scope occur. Firstly, very accurate orientation of the polar scope reticle with the polar scope optical axis is necessary so that the centre of the polar scope reticle, which indicates the celestial pole, is coincident with the polar scope optical axis. Secondly, accurate orientation of the polar scope optical axis parallel to the mount's right ascension axis is necessary so that the mount's right ascension axis is aligned with the celestial pole when the polar scope reticle centre is aligned with the celestial pole.

Thirdly, accurate orientation of the polar scope reticle with the correct hour angle for accurate offsetting of the celestial pole from Polaris, which requires accurate knowledge of the current sidereal time and accurate rotation of the polar scope reticle so that the position of Polaris relative to the celestial pole is correct for the current sidereal time. Fourthly, positioning the user's eye in a position to look comfortably through the polar scope which is often difficult, particularly at higher latitudes where the polar scope is more steeply inclined and the polar scope eyepiece is near the ground.

It is therefore an object of the present invention to provide a more precise, lightweight and easy to use mount for not only a celestial tracking device but also for mounting any one of camera, telescope, locating, recording equipment or other like equipment.

Therefore, the present invention provides a self-guiding mount for celestial observation equipment, the mount comprising a static plate and a rotational axis assembly rotatably mounted to the static plate and about a rotational axis a rotating means for rotating the rotational axis assembly relative to the plate, the mount comprises an optical assembly, a CCD camera and a micro-processor, the self-guiding mount arranged to self-guide and track a movement of a celestial body relative to the earth.

The declination axis assembly may comprise a housing within which the optical assembly, CCD camera and micro-processor are housed.

An optical path, between the optical assembly and a CCD camera, may pass within the declination axis assembly.

The mount may comprise a rotating mechanism for rotating the declination axis assembly and a microprocessor, the microprocessor processes data from the CCD camera and commands the rotating mechanism to rotate the declination axis assembly.

Self-guiding may comprise a closed loop of monitoring the position of a celestial body via the camera, outputting the results to the microprocessor which calculates a correction or desired rotation about the rotation axis and commands the rotational means.

The mount may be an equatorial mount and the rotational axis is a declination axis, the rotational assembly being a declination axis assembly.

The mount may be an altitude/azimuth mount, the rotational axis is an altitude/azimuth axis and the rotational assembly is an altitude/azimuth axis assembly.

In another aspect of the present invention there is provided a celestial observation assembly comprising observation/recording equipment, a stand, a wedge and a self-guiding mount as claimed in any one of the above paragraphs.

In a further aspect of the present invention there is provided a method of polar alignment of a self-guiding mount as described in the above paragraphs.

The present invention will be described in detail with reference to the following drawings in which;

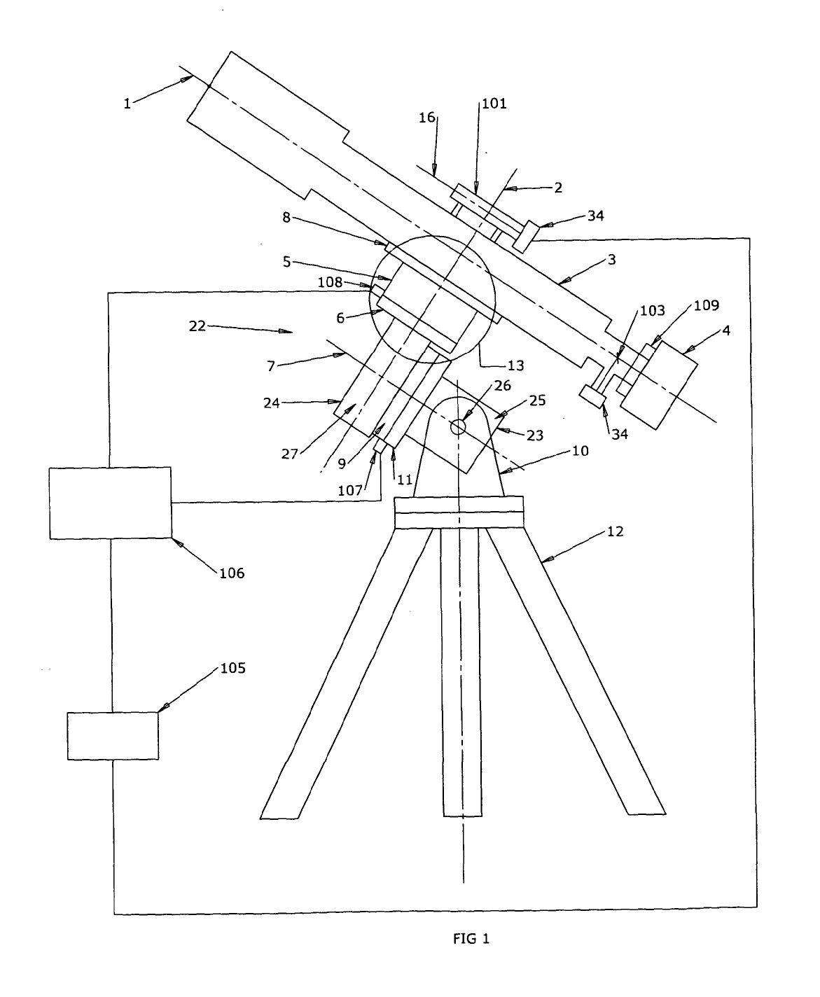

FIG. 1 illustrates a prior art equatorial mounting for celestial observation and recording equipment,

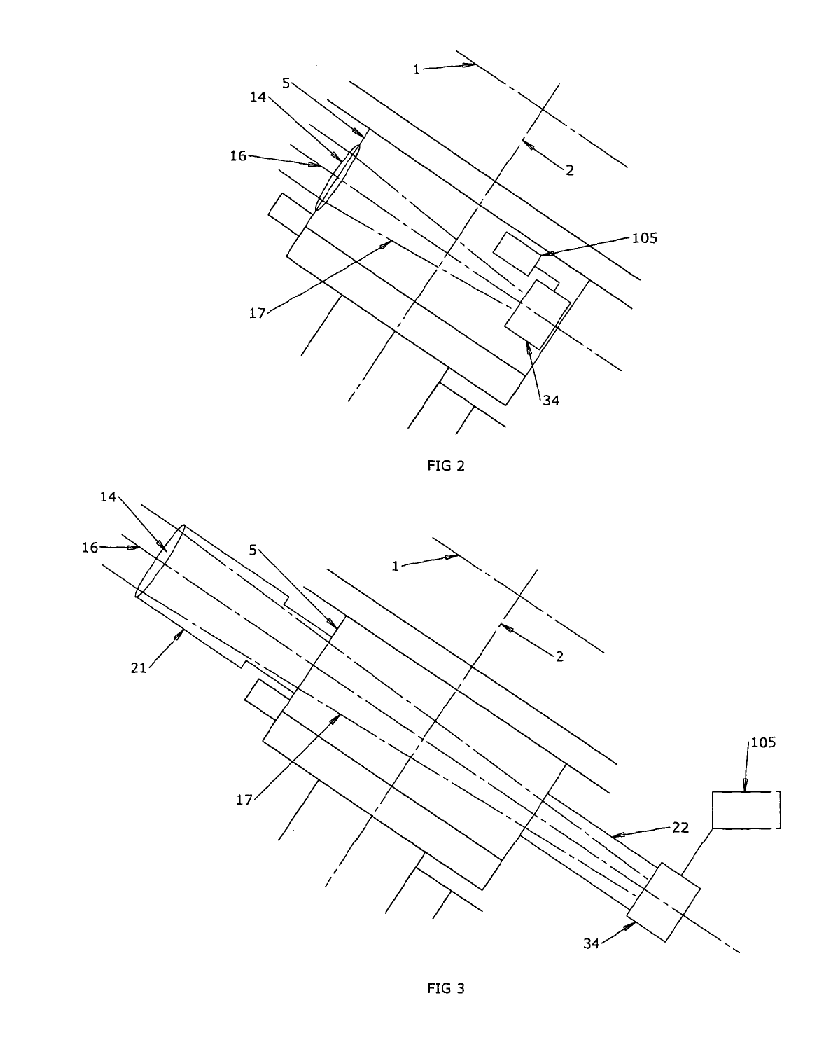

FIG. 2 is a detailed view of the part of the mount encircled 13 in FIG. 1, but now incorporates a first embodiment of self guiding celestial tracking mount in accordance with the present invention,

FIG. 3 is a detailed view of the part of the mount encircled 13 in FIG. 1, but now incorporates a second embodiment of self guiding celestial tracking mount in accordance with the present invention, and

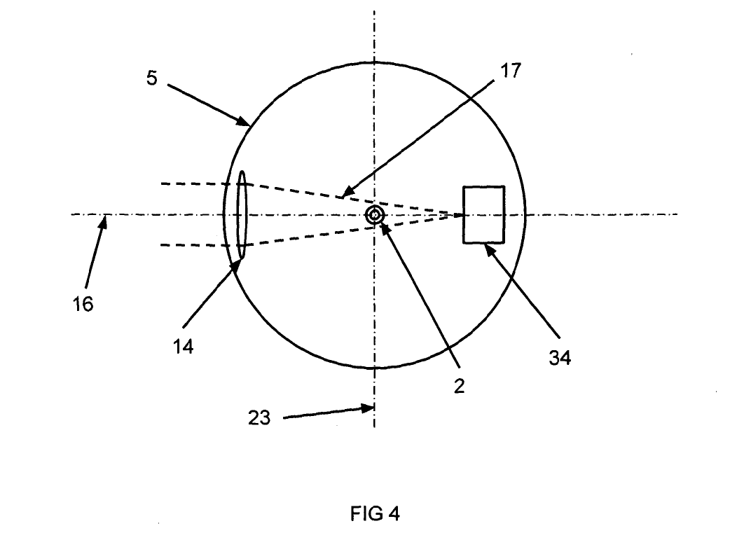

FIG. 4 is a schematic plan view of the declination or altitude axis of the first embodiment of an equatorial or altitude/azimuth mount respectively in accordance with the present invention.

Referring to FIG. 1, a telescope 3 and a primary telescope imaging camera 4 are attached to a mounting plate 8 of an equatorial mount, generally indicated as 22. The equatorial mount 22 comprises a base 11 that is attached to a mount wedge 10. The mount wedge 10 is attached to a tripod 12 that is stood on the ground.

The equatorial mount 22 comprises a first armature 23 attached to the mount wedge 10 and a second armature 24 connecting between the first armature 23 and the telescope. The first armature 23 comprises a first housing 25 rotatably attached at one end to the mount wedge 10 about axis 26 (into the page) and fixedly attached at the other end to the base 11. The first armature 23, once locked in position about axis 26, is static and a plate 9, part of the second armature 24, is rotatably mounted thereon. Rotation of the plate 9 is about a right ascension axis 7. The right ascension axis 7 intersects axis 26 and passes through the plates 11 and 9 and about which plate 9 rotates.

The first armature 23 is locked in position about axis 26 by a locking mechanism, which is well known in the art and needs no further explanation.

The second armature 24 comprises a second housing 27 mounted to the plate 9 and a second static plate 6. The second armature 24 comprises a declination axis housing 5 which is rotatably mounted to the static plate 6. The mounting plate 8 is fixedly attached to the second housing 5. The second armature 24 is rotatable about the right ascension axis 7. The second armature 24 defines a declination axis 2 which intersects right ascension axis 7 perpendicularly. The declination axis housing 5 is rotatable about the declination axis 2.

Bearings (not shown) are provided between the base 11 and plate 9 as well as between the declination axis assembly 5 and static plate 6. Rotating mechanisms are well known in the field; usually comprising an electric motor mounted with the housings 5 and 27 and connected to the rotating plate parts 9 and 5 via worm gear. The rotating mechanisms, including motor drives, are controlled by a microprocessor 105 and motor drive controller 106 that are part of the pointing, tracking and auto-guiding system. A declination/altitude motor drive 108 is located on the declination axis housing 5. A right ascension/azimuth motor drive 107 is located between the rotating plate 9 and base 11 for relative rotation there-between and about the right ascension axis 7.

The telescope 3, primary telescope imaging camera 4 and the equatorial mount 22 are rotatable around the right ascension axis 7 and/or declination axis 2 to facilitate and pointing to, and tracking of, celestial objects which move relative to the earth.

The telescope 3 and camera 4 and the second armature of the equatorial mount can rotate about the declination axis 2 to facilitate pointing to celestial objects.

The mounting wedge 10 is used to align the right ascension axis 7 with the celestial pole. Typically, the wedge comprises a rotational axis normal to the plane of the paper or in use parallel to ground plane or azimuth plane. A threaded and tightening screw is used to allow rotation and clamping and which is also a rotational axis in the plane of the paper. The wedge has two axes, one in altitude and one in azimuth, it is in itself a static altitude/azimuth mounting base, and is most commonly used in conjunction with the equatorial configuration of the mount.

The telescope 3 is mountable and dis-mountable to the mounting plate 8. The imaging camera 4 is attached to the sighting end of the telescope in normal fashion and is preferably near to the focal point of the telescope. The camera 4 is used for taking images of a celestial object. For auto-guiding, a second or auto-guider camera 34 is typically mounted externally of the telescope and a prism 103 or other optical means is used to direct an image, passing through the telescope, into the auto-guider camera. This auto-guider camera is often termed a ‘charged couple device’ or CCD camera. Alternatively, or as well as, a CMOS camera may be used. The imaging camera 4 is most often a digital single lens reflex camera or digital SLR camera or scientific CCD or CMOS camera. This digital SLR camera has no integrated auto-guiding functionality.

Alternatively, a second and usually lower resolution or shorter focal length telescope 101 is provided on an off-set axis 16 parallel to the main telescope's observation axis 1. An auto-guiding camera 34 is then attached to this second telescope for use in auto-guiding.

Mounted between the primary telescope imaging camera 4 and telescope 3 is an optional field-derotator 109 as known in the art.

The images from the auto-guiding camera 34 are fed via cabling to the microprocessor and an image is tracked and the rate of rotation about the declination axis and right ascension axis is thereby controlled.

Currently telescope mount manufacturers have designed an astronomical telescope mount with high precision drive gears, transmissions with accurate motor speed control. Success in tracking a star is directly linked to these features. During the course of an imaging/observing, a deviation between the apparent location of the star and where the mount is pointing will lead to a loss of resolution and quality of the desired image. This is due to inaccuracies in the mechanical and electrical components of the telescope and mounts system. Air turbulence, refraction and lens properties of the Earth's atmosphere will also cause a star to be displaced from its theoretical position in the sky.

The standard practice of auto-guiding a telescope mount is utilised to compensate for deviations caused by the above. Current convention requires the addition of an auto-guider camera and scope to the mount and telescope as accessories, which are usually mounted adjacent to the main telescope. Correction signals are generated by a microprocessor via the auto-guider camera and sent to the mount to make the necessary movements to re-centre or eliminate observed/imaged displacements, where the object is not in the centre of the image frame, of the celestial object whilst tracking. It should be appreciated that the microprocessor may be located anywhere convenient although in this exemplary embodiment, located in the camera.

The current bolt-on auto-guider is generally expected to guide a mount with sub arc second accuracy that is to an accuracy of at least +/−1 arc-second. In appreciating an angle subtended by one arc second is one part in 1,296,000 of a full circle, it is vital that the recording/observing equipment tracks a celestial body very accurately.

Another serious problem of the prior art is that the auto-guiding camera is mounted on the sight end of the telescope and therefore a significant distance away from the declination axis. This can result in magnification of any out-of-plane rotation between the rotating declination axis housing 5 and the static plate 6. Furthermore, vibrations and flexure of the equipment is again amplified.

Another of the main problems of the prior art devices is the difficulty of transportation particularly with respect to human portability. Along with all the other equipment described above, a separate auto-guider camera is required along with its mountings and possibly second telescope.

Turning now to FIGS. 2 and 4 and the first embodiment of the self-guiding celestial tracking mount and its assembly; there is illustrated an auto-guider system integrated into the declination axis assembly 5 of an auto-guiding equatorial mount, by way of example. The auto-guiding equatorial mount is self-guiding and tracks celestial objects without additional equipment.

The auto-guider comprises an optical assembly 14, an optical path 17 and CCD or CMOS camera 34 and a microprocessor 105 for controlling a rotation about the declination axis 2 and right ascension axis 7 (as shown in FIG. 1). Where the present invention is utilised in an altitude/azimuth mount, the rotation may be both about the altitude and azimuth axes, together with an optional field de-rotator as known in the art. In this embodiment, the optical assembly 14 is built into a wall of the housing. Significantly, the optical path 17 is at least partly within the declination axis assembly 5 which is rotatable about the declination axis and therefore any out-of-plane irregularities in the rotational plane are greatly minimised.

Furthermore, the self-guiding celestial tracking mount is compact and more easily transportable. It is also more robust and for the user is a single piece of apparatus from one manufacturer thereby obviating any compatibility problems of multiple manufacturers.

This configuration of the equatorial mount locates the optical axis of the auto-guider coincident with and perpendicular to the declination axis. The resulting symmetry is advantageous in achieving balance and obviating additional counterweights that would need to be transported by the user.

This configuration of the equatorial mount also extends the length of the declination axis assembly (normal distance between right ascension and auto-guider axes) which is advantageous in that it increases the time for which the mount can track past the meridian without performing a ‘Meridian Flip’ when operating in equatorial mode.

In this configuration of the invention, the auto-guider system elements are located entirely within the declination axis assembly 5.

The illustration depicts the auto-guider elements on a straight optical path 16, but it is possible for the elements to be arranged on a non-linear path using additional optical elements such as mirrors, prisms and lenses. This can create a longer optical path within a relatively small declination axis assembly 5.

It is desirable for the auto-guider optical axis 16 to be approximately parallel to the optical path 1 of the celestial observation and recording equipment for accurate feedback and control of the equatorial mount. Therein lies a further advantage of the present invention, because the means of mounting the observing or recording equipment, typically screws or brackets, can be machined and attached to the mount such that they are aligned with the auto-guider optical axis.

Regarding FIG. 4 where like elements are consistent with FIG. 2, the axis 23 is perpendicular with the optical axis 16 and coincident with the declination axis 2. Advantageously, coincidence of the auto-guider optical axis 16 with the declination axis 2, perpendicular to the page, results in symmetrical weight distribution either side of the optical axis. This symmetry ensures good balance and obviates counterweights. Similarly, the auto-guider elements 14 and 4 are positioned fore and aft the optical axis 16 to achieve symmetrical weight distribution about axis 23 obviating counterweights.

FIG. 3 illustrates an alternative configuration of the auto-guider in which the optical assembly 14 and/or camera 34 are located outside the declination axis 5.

The self-guiding celestial tracking mount and assembly provides a solution to the auto-guiding problems described in the preamble by incorporating the auto-guiding camera and optics into the celestial object tracking mount axis to which the celestial observation or recording equipment is attached. This provides the following benefits:
a. rigid coupling between the auto-guiding camera and optics and the celestial object tracking mount reducing auto-guiding errors.
b. a reduction in size and weight, particularly beneficial for portable celestial object tracking mounts.
c. typically a cost saving to the user as the auto-guiding camera and optics are integrated by the original equipment manufacturer.

The self-guiding celestial tracking mount provides a solution to the pointing problems described in the preamble by incorporating the ‘finder’ camera and optics into the celestial object tracking mount axis to which the celestial observation or recording equipment is attached. In particular, the same camera and optics may be used for both auto-guiding and ‘finder’ functions.

The self-guiding celestial tracking mount provides a solution to the polar alignment problems described in the preamble by incorporating the polar scope camera and optics into the celestial object tracking mount axis to which the celestial observation or recording equipment is attached. In particular, the same camera and optics may be used for auto-guiding, ‘finder’, polar alignment and field de-rotation functions.

Additionally, axis position sensors may be used in conjunction with the polar alignment optics and camera to assist in polar alignment. The axis position sensors are typically optical, mechanical or magnetic and are used to determine the angular position of the rotatable part of the declination and right ascension axes with respect to the static part of each axis. For polar alignment, the polar alignment optical axis must be parallel to the right ascension axis which is achieved by rotating the declination axis until the polar alignment optical axis is parallel to the right ascension axis.

Although the lens and camera are built-in items to the mount they are intended to be replaceable and upgradeable assemblies. Camera mounting permits small adjustments of position of camera or lens assemblies.

In accordance with the present invention the mount is self-guiding which comprises a closed loop of monitoring the position of a celestial body via the camera, outputting the results to the microprocessor which compares the observed position of the celestial body between successive frames and calculating a correction or desired rotation about the rotation axis and commands the rotational means to rotate the rotational axis assembly to the correct position.

Although the microprocessor and data processing may be a part of the celestial tracking equipment, in another embodiment the microprocessor may be advantageously external and typically in the form of software running on a personal computer. Such a personal computer may be a commonly available hand held device such as a smart phone or other device. In this configuration, the camera, optics and mounting are integral to the mount and the software is external to the mount.

The term ‘pointing and ‘finding’ comprises a method of alignment of the axis of the celestial observation or recording equipment with the optical axis of the built-in optics and camera such that the built-in camera's field of view coincides with the field of view in the celestial observation or recording equipment.

Polar alignment and a method of polar alignment comprises firstly orienting the mount's axes such that the polar alignment camera optical path is parallel with the right ascension axis by means of right ascension and declination axes position sensors. Secondly, pointing the polar alignment optics and camera so the camera's field of view is roughly centred on the celestial pole and outputting the results to a microprocessor which identifies stars in the camera's field of view so that the position of the celestial pole can be calculated. Thirdly, using the difference between the calculated position of the celestial pole and the actual position of the right ascension axis assists in adjusting the wedge so as to bring the right ascension axis coincident with the celestial pole. The camera and microprocessor can be connected to motor drives in the wedge to provide a closed loop such that the mount's right ascension axis is automatically aligned with the celestial pole. Alternatively, the deviation of the mount's right ascension axis from the celestial pole can be displayed to the user, typically on a computer screen, and manual user adjustments made to the wedge to bring the mount's right ascension axis coincident with the celestial pole.

Thus tracking celestial objects using a self-guiding celestial observation assembly comprises a mount wedge 10 and a mount for celestial observation equipment as described herein before. The steps of tracking comprise selecting an object to be tracked and tracking the object via a closed loop system by rotating the rotating mechanism(s) about the rotational axis (2) and/or the right ascension axis (7). Provision of a microprocessor 105, either integrally (as shown in FIG. 2) or via an external computer (as shown in FIG. 3), allows processing data from the camera 34 to command the rotating mechanism(s) to rotate about the rotational axis 2 and/or the right ascension axis 7.

The principals of the above described self-guiding declination mount are readily applicable to an altitude/azimuth mount. Here the rotational axis is an altitude/azimuth axis and the rotational assembly is described as an altitude/azimuth axis assembly. An altitude/azimuth mount is similar in all respects to an equatorial mount except that the right ascension axis rotates in a plane parallel to the ground (azimuth) and the altitude axis rotates in a plane perpendicular to the ground (altitude). Other minor differences between a declination mount and an altitude/azimuth mount will be apparent to a skilled artisan.

In summary some of the main advantages of the present invention comprise

1. the self-guiding mount to track a star by constant monitoring of a field star without the requirement of a separate auto-guiding camera and scope;

2. the self-guiding mount overcomes the problems associated with differential deflection between the guide-scope and the mount. This enhances the accuracy of observing and/or recording celestial bodies;

3. the self-guiding mount minimises balance offsets and increased weight issues attributed to the addition of a separate auto-guider system and associated mounting fixtures; and

4. the self-guiding mount reduces the time of setting up a separate auto-guider system.

1. A self-guiding mount for celestial observation equipment, the mount comprising
a static plate (6) and
a rotational as assembly (5) rotatably mounted to the static plate (6) and about a rotational axis (2)
a rotating means for rotating the rotational axis assembly (5) relative to the plate (6),
the mount comprises an optical assembly (14), a CCD camera (40) and a micro-processor,
the self-guiding mount arranged to self-guide and track a movement of a celestial body relative to the earth.

2. A self-guiding mount as claimed in claim 1 wherein the declination axis assembly (5) comprises a housing within which the optical assembly (14), CCD camera (40) and micro-processor are housed.

3. A self-guiding mount as claimed in any one of claims 1-2 wherein an optical path (16, 19), between the optical assembly (14) and a CCD camera (40), passes within the declination axis assembly (5).

4. A self-guiding mount as claimed in claim 1 comprising a rotating mechanism for rotating the declination axis assembly (5) and a microprocessor, the microprocessor processes data from the CCD camera and commands the rotating mechanism to rotate the declination axis assembly (5).

5. A self-guiding mount as claimed in any one of claims 1-4 wherein self-guiding comprises a closed loop of monitoring the position of a celestial body via the camera, outputting the results to the microprocessor which calculates a correction or desired rotation about the rotation axis and commands the rotational means.

6. A self-guiding mount as claimed in any one of claims 1-5 wherein the mount is an equatorial mount and the rotational axis is a declination axis, the rotational assembly being a declination axis assembly.

7. A self-guiding mount as claimed in any one of claims 1-5 wherein the mount is an altitude/azimuth mount, the rotational axis is an altitude/azimuth axis and the rotational assembly is an altitude/azimuth axis assembly.

8. A celestial observation assembly comprising observation/recording equipment, a stand, a wedge and a self-guiding mount as claimed in any one of claims 1-7.

9. A self-guiding mount as hereinbefore described with reference to the figures.

10. A self-guiding mount substantially as described in this specification and with reference to and as shown in FIGS. 2-3 of the accompanying drawings.

11. A method of polar alignment of a self-guiding mount substantially as described in this specification and with reference to and as shown in FIGS. 2-3 of the accompanying drawings.
